(19) United States
(12) Patent Application Publication
(10) Pub. No.: US 2021/0248935 A1
(43) Pub. Date: Aug. 12, 2021

(54) Ornamental Window Assembly

(71) Applicant: Thomas Christenson, Sierra Vista, AZ (US)

(72) Inventor: Thomas Christenson, Sierra Vista, AZ (US)

(21) Appl. No.: 16/787,853

(22) Filed: Feb. 11, 2020

(51) Int. Cl. G09F 13/00; E06B 3/66; E06B 5/00

(52) U.S. Cl. CPC G09F 13/00; E06B 5/00; E06B 3/66

(57) ABSTRACT

A ornamental window assembly for enhancing the ornamental appeal of a window opening includes a first window pane that is positionable in a window opening. A second window pane is provided and the second window pane is positionable in the window opening. The second window pane is spaced from the first window pane to define an ornament space between the first window pane and the second window pane. An ornament is provided and the ornament is positioned in the ornament space to enhance visual appeal of the window opening.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ornamental devices and more particularly pertains to a new ornamental device for enhancing the ornamental appeal of a window opening.

### (2) Description of Related Art Including Information Disclosed Under 37 CFR 1.97 and 1.98

The prior art relates to ornamental devices. The prior art discloses a window pane assembly that includes a tinted pane that is sandwiched between a pair of clear window panes. The prior art discloses a window grid that is positionable between a pair of window panes. Additionally, the prior art discloses a prefabricated window frame that includes a window pane, an ornamental pane and a lattice positioned therebetween. The prior art also discloses a method of manufacturing a window that includes a decorative polymer panel. The prior art discloses a window pane assembly that includes a mounting unit being positioned between a pair of window panes and an ornament that is attachable to the mounting unit.

### BRIEF SUMMARY OF THE INVENTION

An embodiment of the disclosure meets the needs presented above by generally comprising a first window pane that is positionable in a window opening. A second window pane is provided and the second window pane is positionable in the window opening. The second window pane is spaced from the first window pane to define an ornament space between the first window pane and the second window pane. An ornament is provided and the ornament is positioned in the ornament space to enhance visual appeal of the window opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an ornamental window assembly according to an embodiment of the disclosure.

FIG. 2 is a cross sectional view taken along line 2-2 of FIG. 1 of an embodiment of the disclosure.

FIG. 3 is a front view of an embodiment of the disclosure.

FIG. 4 is a perspective in-use view of an embodiment of the disclosure.

### DETAILED DESCRIPTION OF THE INVENTION

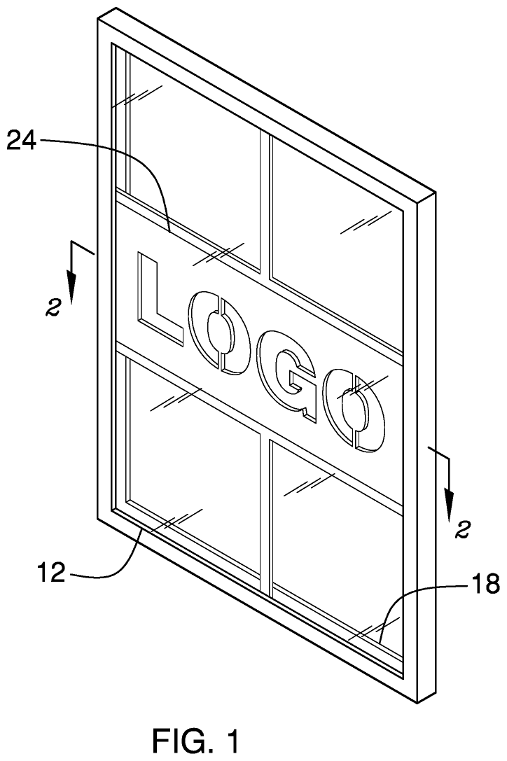

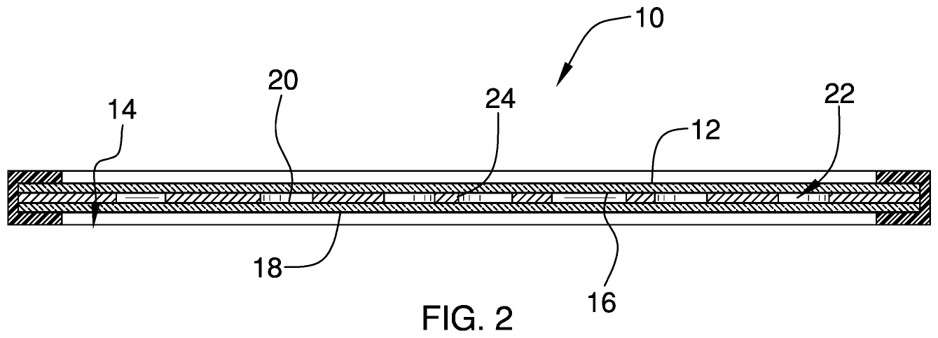

With reference now to the drawings, and in particular to FIGS. 1 through 4 thereof, a new ornamental device embodying the principles and concepts of an embodiment of the disclosure and generally designated by the reference numeral 10 will be described.

As best illustrated in FIGS. 1 through 4, the ornamental window assembly 10 generally comprises a first window pane 12 that is positionable in a window opening 14 and the first window pane 12 has a first surface 16. The first window pane 12 is comprised of a translucent material to facilitate the window opening 14 to be seen through. The window opening 14 may be a window opening in a door, a window opening in a wall or any other type of window opening.

A second window pane 18 is provided and the second window pane 18 is positionable in the window opening 14. The second window pane 18 is comprised of a translucent material to facilitate the window opening 14 to be seen through and the second window pane 18 has a second surface 20. The second surface 20 is directed toward the first surface 16 of the first window pane 12 having the second window pane 18 being spaced from the first window pane 12 to define an ornament space 22 between the first window pane 12 and the second window pane 18.

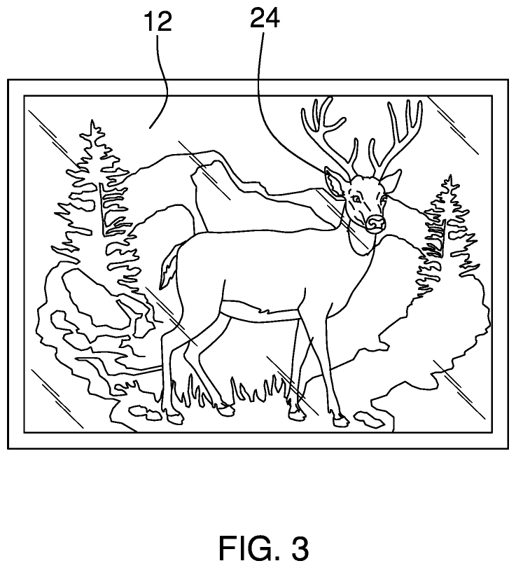

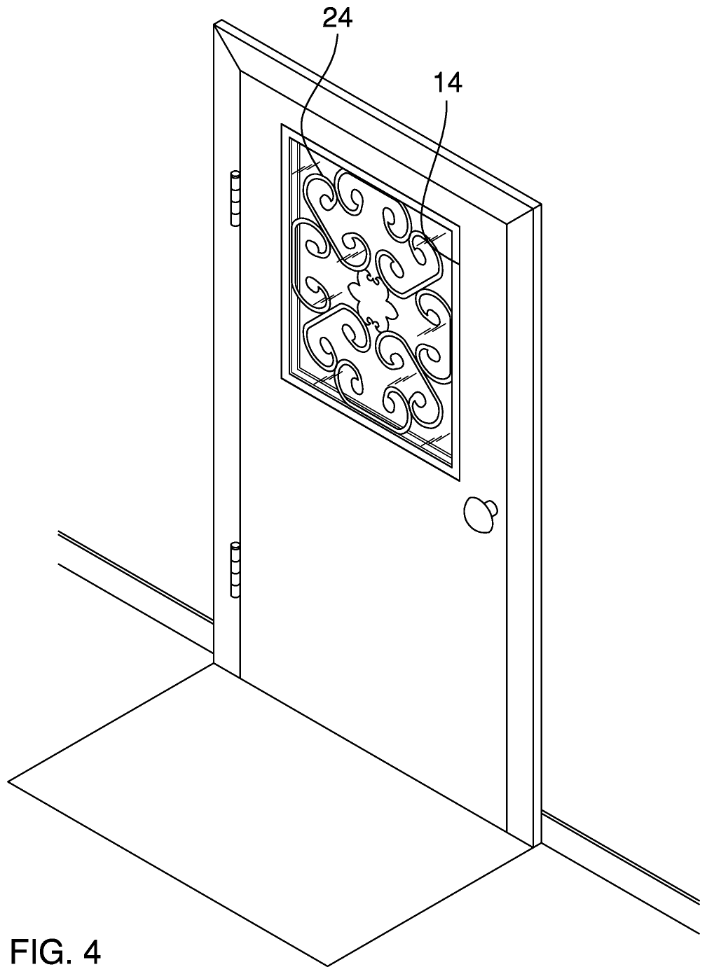

An ornament 24 is provided and the ornament 24 is positioned in the ornament space 22 to enhance visual appeal of the window opening 14. As is most clearly shown in FIG. 1, the ornament 24 may be structured to define a plurality of letters spelling words to display a readable logo or phrase. As is most clearly shown in FIG. 3, the ornament 24 may be structured to define outlines of a pre-determined image to display the image to an observer. As is most clearly shown in FIG. 4, the ornament 24 may be structured to define a pre-determined geometric shape to display the pre-determined geometric shape to the observer.

In use, the ornament 24 is positioned between each of the first window pane 12 and the second window pane 18 when the first window pane 12 and the second window pane 18 are installed in the window opening 14. In this way the ornament 24 is visible in the window opening 14 for enhancing the visual appeal of the window opening 14. Either of the first window pane 12 or the second window pane 18 can be removed from the window opening 14 for removing or replacing the ornament 24. In this way the window opening 14 can be decorated with a variety of different ornaments 24 or the window opening 14 can be displayed without the ornament 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An ornamental window assembly being configured to integrate an image into a window, said assembly comprising:
a first window pane being positionable in a window opening;
a second window pane being positionable in the window opening, said second window pane being spaced from said first window pane to define an ornament space between said first window pane and said second window pane; and
an ornament being positioned in said ornament space wherein said ornament is configured to enhance visual appeal of the window opening, said ornament comprising a single layer of material having flat outer faces, each of said flat outer faces abutting a respective one of said first window pane and said second window pane.

2. The assembly according to claim 1, wherein said first window pane is comprised of a translucent material wherein said first window pane is glass is configured to facilitate the window opening to be seen through, said first window pane having a first surface.

3. The assembly according to claim 2, wherein said second window pane is comprised of a translucent material wherein said second window pane is configured to facilitate the window opening to be seen through, said second window pane having a second surface, said second surface being directed toward said first surface of said first window panel to define said ornament space between said first window pane and said second window pane.

4. The assembly according to claim 1, wherein said ornament is structured to define a plurality of letters spelling words wherein said ornament is configured to display a readable logo or phrase.

5. The assembly according to claim 1, wherein said ornament is structured to define outlines of a pre-determined image wherein said ornament is configured to display the image to an observer.

6. The assembly according to claim 1, wherein said ornament is structured to define a pre-determined geometric shape wherein said ornament is configured to display the pre-determined geometric shape to the observer.

7. An ornamental window assembly being configured to integrate an image into a window, said assembly comprising:
a first window pane being positionable in a window opening, said first window pane being comprised of a translucent material wherein said first window pane is glass is configured to facilitate the window opening to be seen through, said first window pane having a first surface;
a second window pane being positionable in the window opening, said second window pane being comprised of a translucent material wherein said second window pane is configured to facilitate the window opening to be seen through, said second window pane having a second surface, said second surface being directed toward said first surface of said first window pane having said second window pane being spaced from said first window pane to define an ornament space between said first window pane and said second window pane; and
an ornament being positioned in said ornament space wherein said ornament is configured to enhance visual appeal of the window opening, said ornament being structured to define a plurality of letters spelling words wherein said ornament is configured to display a readable logo or phrase, said ornament being structured to define outlines of a pre-determined image wherein said ornament is configured to display the image to an observer, said ornament being structured to define a pre-determined geometric shape wherein said ornament is configured to display the pre-determined geometric shape to the observer, said ornament comprising a single layer of material having flat outer faces, each of said flat outer faces abutting a respective one of said first window pane and said second window pane.

8. A method of displaying an image in a window opening, the steps of the method comprising:
providing a first window pane being positionable in a window opening;
providing a second window pane being positionable in the window opening, said second window pane being aligned with and being spaced from said first window pane to define an ornament space between said first window pane and said second window pane;
providing an ornament being structured to define a pre-determined image, said ornament comprising a single layer of material having flat outer faces, each of said flat outer faces abutting a respective one of said first window pane and said second window pane; and
positioning said ornament in said ornament space when said first window pane and said second window pane are installed in the window opening.
